(19) United States
(12) Patent Application Publication
(10) Pub. No.: US 2014/0321727 A1
(43) Pub. Date: Oct. 30, 2014

(54) IMAGE PROCESSING APPARATUS, IMAGE PROCESSING METHOD AND STORAGE MEDIUM

(71) Applicants: Atsutaka Okizaki, Asahikawa-shi (JP); Tamio Aburano, Asahikawa-shi (JP)

(72) Inventors: Atsutaka Okizaki, Asahikawa-shi (JP); Tamio Aburano, Asahikawa-shi (JP)

(73) Assignee: National University Corporation Asahikawa Medical University, Asahikawa-shi, Hokkaido (JP)

(21) Appl. No.: 14/239,888

(22) PCT Filed: Aug. 10, 2012
(86) PCT No.: PCT/JP2012/070470

§ 371 Date: May 20, 2014

(30) Foreign Application Priority Data
Aug. 22, 2011 (JP) 2011-180065

(51) Int. Cl. G06K 9/20; G06T 11/00; G06T 7/00

(52) U.S. Cl. CPC G06K 9/2054; G06T 7/0012; G06T 11/005
USPC 382/131

(57) ABSTRACT

An image processing apparatus includes: a region-of-interest setting information storage unit in which region-of-interest setting information for setting one or more regions of interest in a specified cross-sectional image is stored; an evaluation value acquiring unit that acquires, using measured values, an evaluation value for evaluating a region of interest in the specified cross-sectional image, for each region of interest indicated by the region-of-interest setting information, and acquires, using measured values, a related evaluation value for evaluating a region in one or more cross-sectional images other than the specified cross-sectional image, for each region corresponding to each region of interest indicated by the region-of-interest setting information; and an output unit that outputs the acquired evaluation value and related evaluation value in association with the specified cross-sectional image corresponding to the evaluation value and the cross-sectional image corresponding to the related evaluation value.

### CROSS-REFERENCE TO RELATED APPLICATIONS

This is a U.S. national phase application under 35 U.S.C. §371 of International Patent Application No. PCT/JP2012/070470, filed on Aug. 10, 2012, and claims benefit of priority to Japanese Patent Application No. JP 2011-180065, filed on Aug. 22, 2011. The International application was published on Feb. 28, 2013, as International Publication No. WO 2013/027607 under PCT Article 21(2). The entire contents of these applications are hereby incorporated by reference.

### TECHNICAL FIELD

The present invention relates to an apparatus and the like for processing a cross-sectional image of a living body.

### BACKGROUND ART

Known examples of techniques that produce tomographic images of a living body such as a human body include positron emission tomography (PET), single photon emission CT (SPECT), magnetic resonance imaging (MRI), computed tomography (CT), and the like. There is a known conventional image processing apparatus for processing a cross-sectional image of a human body acquired using such a technique, including: normalized data storage units in which a normalized SPECT image and a normalized MRI image of a specific region of the same person are respectively stored; a comparison calculation unit that performs specific calculation using the normalized SPECT image and the normalized MRI image; and a display control unit that performs processing for displaying an image of the specific region on a display apparatus based on the calculation result (see Patent Document 1, for example).

### CITATION LIST

### Patent Document

[Patent Document 1] JP 2008-125658A (p. 1, FIG. 1, etc.)

### SUMMARY OF INVENTION

### Technical Problem

However, such a conventional image processing apparatus is problematic in that it is difficult to easily set a proper region of interest in a cross-sectional image. For example, a region of interest is preferably set at the center of a lesion in a cross-sectional image. When setting such a region of interest in a cross-sectional image, typically, a user in many cases manually sets the region of interest while visually judging the color of pixels indicating a lesion. However, the setting of a region based on visual judgment in this manner is problematic in that, for example, if a difference between the colors of two adjacent pixels is small, determining the range of pixels that are to be included in the region of interest is difficult, which makes it impossible to set a proper region of interest. Accordingly, for example, in clinical practice and the like, whether or not a region of interest set in a cross-sectional image has been properly set substantially at the center of a lesion is judged by comparison between that cross-sectional image and one or more cross-sectional images acquired before or after that cross-sectional image, regarding pixels at the position corresponding to the region of interest. However, the process that judges whether or not a proper region of interest has been set, by comparing the multiple cross-sectional images in this manner, requires an inordinate amount of effort, and, thus, it is problematic in that a proper region of interest cannot be easily set.

### Solution to Problem

The present invention is directed to an image processing apparatus, comprising: a cross-sectional image storage unit in which multiple cross-sectional images, which are images showing cross-sections of a living body produced using measured values, and are multiple images respectively acquired at different multiple positions in a predetermined direction, are stored in association with the arrangement order of the acquisition positions; an operation accepting unit that accepts an operation that specifies a cross-sectional image stored in the cross-sectional image storage unit; a region-of-interest setting information storage unit in which region-of-interest setting information, which is information for setting at least one region of interest in a specified cross-sectional image specified by the operation, is stored; an evaluation value acquiring unit that acquires, using the measured values, an evaluation value, which is a value for evaluating a region of interest in the specified cross-sectional image, for each region of interest indicated by the region-of-interest setting information, and acquires, using the measured values, a related evaluation value, which is a value for evaluating a region in at least one cross-sectional image other than the specified cross-sectional image, for each region corresponding to each region of interest indicated by the region-of-interest setting information; and an output unit that outputs the evaluation value and the related evaluation value acquired by the evaluation value acquiring unit, in association with the specified cross-sectional image corresponding to the evaluation value and the cross-sectional image corresponding to the related evaluation value.

With this configuration, a related evaluation value of a region corresponding to the region of interest can be easily obtained in a cross-sectional image other than the specified cross-sectional image. Thus, a proper region of interest can be easily set in the cross-sectional image.

Furthermore, the image processing apparatus of the present invention is configured such that the evaluation value acquiring unit acquires a related evaluation value in at least one cross-sectional image whose arrangement order is consecutive with that of the specified cross-sectional image.

With this configuration, a related evaluation value of a region corresponding to the region of interest can be easily obtained in a cross-sectional image consecutive with the specified cross-sectional image. Thus, a more proper region of interest can be easily set in the cross-sectional image.

Furthermore, the image processing apparatus of the present invention further includes: a region-of-interest operation accepting unit that accepts an operation that changes the region of interest; and a region-of-interest setting information accumulating unit that accumulates, in the region-of-interest setting information storage unit, region-of-interest setting information for setting a region of interest after change according to the change operation; wherein the evaluation value acquiring unit acquires the evaluation value and the related evaluation value for the region of interest after change.

With this configuration, the evaluation value and the related evaluation value in the case where the region of interest is changed can be acquired. Accordingly, for example, the change in the region of interest can be reflected in real-time in the evaluation value and the related evaluation value that are to be output, and, thus, the operation performance is improved.

Furthermore, the image processing apparatus of the present invention is configured such that the operation accepting unit further accepts an operation that changes the specified cross-sectional image, the image processing apparatus further includes a region-of-interest setting information accumulating unit that acquires, for the specified cross-sectional image after change, the same region-of-interest setting information as that of the specified cross-sectional image before change, and accumulates the region-of-interest setting information in the region-of-interest setting information storage unit, and the evaluation value acquiring unit acquires the evaluation value and the related evaluation value in the specified cross-sectional image after change and at least one cross-sectional image other than the specified cross-sectional image.

With this configuration, the evaluation value and the related evaluation value in the case where the specified cross-sectional image is changed can be acquired. Accordingly, for example, the change in the specified cross-sectional image can be reflected in real-time in the evaluation value and the related evaluation value that are to be output, and, thus, the operation performance is improved.

Furthermore, the image processing apparatus of the present invention is configured such that the output unit outputs the evaluation value and the related evaluation value using at least one of a bar graph, a graph other than a bar graph, a color brightness, a color tone, and a numerical value.

With this configuration, the evaluation value and the related evaluation value corresponding to the respective cross-sectional images can be easily compared.

Furthermore, the image processing apparatus of the present invention is configured such that the output unit performs output such that the specified cross-sectional image or the cross-sectional image associated with the evaluation value or the related evaluation value with the highest evaluation is emphasized.

With this configuration, the cross-sectional image having the evaluation value or the related evaluation value with the highest evaluation can be easily recognized.

### Advantageous Effects of Invention

With the image processing apparatus and the like according to the present invention, a proper region of interest can be easily set in a cross-sectional image.

### BRIEF DESCRIPTION OF DRAWINGS

FIG. 1 is a block diagram of an image processing apparatus according to an embodiment of the present invention.

FIG. 2 is a flowchart illustrating an operation of this embodiment.

FIG. 3 is a table showing cross-sectional image management information of this embodiment.

FIG. 4 is a view showing a display example of this embodiment.

FIG. 5 is a view showing a display example of this embodiment.

FIG. 6 is a table showing region-of-interest management information of this embodiment.

FIG. 7 is a table showing measurement acquired value management information of this embodiment.

FIG. 8 is a table showing evaluation value management information of this embodiment.

FIG. 9 is a view showing an output example of this embodiment.

FIG. 10 is a view showing an output example of this embodiment.

FIG. 11 is a view showing an exemplary appearance of a computer system according to the embodiment of the present invention.

FIG. 12 is a diagram showing an exemplary configuration of the computer system of this embodiment.

### DESCRIPTION OF EMBODIMENT

Hereinafter, an embodiment of an image processing apparatus and the like will be described with reference to the drawings. Note that constituent elements denoted by the same reference numerals perform the same operations in the embodiments, and, thus, a description thereof may not be repeated.

### EMBODIMENT

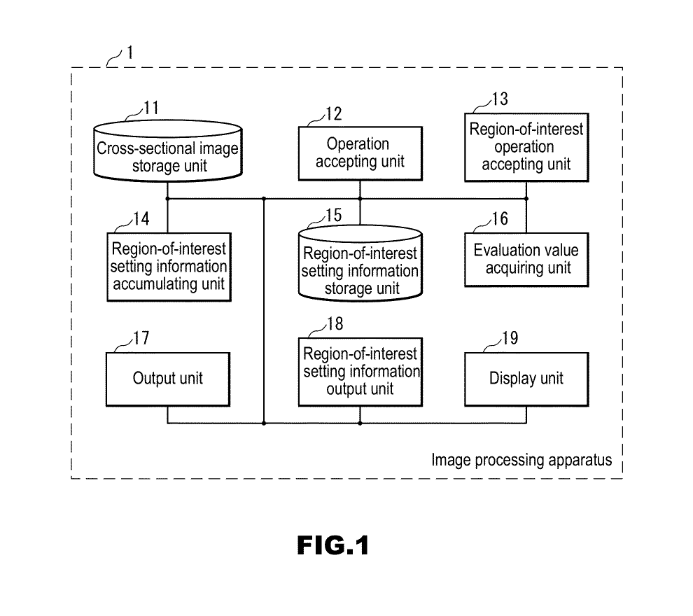

FIG. 1 is a block diagram of an image processing apparatus 1 in this embodiment.

The image processing apparatus 1 includes a cross-sectional image storage unit 11, an operation accepting unit 12, a region-of-interest operation accepting unit 13, a region-of-interest setting information accumulating unit 14, a region-of-interest setting information storage unit 15, an evaluation value acquiring unit 16, an output unit 17, a region-of-interest setting information output unit 18, and a display unit 19.

In the cross-sectional image storage unit 11, multiple cross-sectional images are stored. A cross-sectional image is an image showing a cross-section of a living body, produced using measured values obtained from the living body. A cross-sectional image is typically referred to as a slice. A living body is, for example, a human body or an animal body. In the cross-sectional image storage unit 11, multiple cross-sectional images of at least one living body, which are respectively acquired at different multiple positions in a predetermined direction of that living body, are stored. The predetermined direction is, for example, the body height direction (height direction) of the living body. Note that the predetermined direction may be another direction, such as a direction perpendicular to the body height direction. The different multiple positions are typically multiple positions arranged at predetermined intervals in the predetermined direction such as the body height direction. Note that the different multiple positions may be predetermined multiple positions. A cross-section in the case where the predetermined direction is the body height direction is, for example, a cross-section perpendicular to the body height direction of a living body. Assuming that a cross-sectional image is along an xy plane, cross-sectional images acquired at different positions may be considered as cross-sectional images obtained by shifting the cross-sectional image in a z axis direction. That is to say, the cross-sectional images may be considered as those obtained by slicing along planes having different z axis values. In the cross-sectional image storage unit 11, multiple cross-sectional images are stored in association with the arrangement order of the acquisition positions. The state of being stored in association with the arrangement order may be a state in which the cross-sectional images are stored so as to be arranged in the arrangement order, or may be a state in which the cross-sectional image are stored in association with information such as the numbers indicating the arrangement order. The cross-sectional images may be stored in the cross-sectional image storage unit 11 in association with information indicating the acquisition positions of the cross-sectional images. The multiple cross-sectional images respectively acquired at different multiple positions in a predetermined direction of a living body are preferably, for example, multiple cross-sectional images of that living body sequentially acquired at the same timing (e.g., around the same time of the same day). The same is applied to the description below. In the cross-sectional image storage unit 11, multiple cross-sectional images similar to those described above acquired from multiple different living bodies may be stored in association with information or the like for identifying each living body. Furthermore, multiple cross-sectional images similar to those described above acquired from a living body at different timings (e.g., at different times such as different days, etc.) may be stored.

The cross-sectional image is, for example, a radiographic image such as a SPECT image captured by a single photon emission computed tomography (SPECT) device or a PET image captured by a positron emission tomography (PET) device. Alternatively, the cross-sectional image may be a cross-sectional image of a living body acquired by an X-ray CT device, a magnetic resonance imaging (MRI) device, an ultrasonic diagnostic device, or the like. The cross-sectional image is an image in which a measured value obtained by these devices, a value obtained by modifying the measured value, or the like is replaced by a color value. In this example, a measured value acquired by measurement, or a value obtained by modifying the measured value is referred to as a measurement acquired value. A color value of a pixel is, for example, a color value such as a hue value, a brightness value, a saturation value, and an RGB value of the pixel, a gradation value of gray scale, monochromatic gradation, or the like, and a combination of two or more of these values. A cross-sectional image such as a PET image or a SPECT image captured by administrating a radiopharmaceutical, which is a so-called tracer, to a living body, is an image in which a measurement acquired value indicating the tracer accumulation amount, concentration, or the like measured at each point in the living body is converted to a color value according to predetermined conditions. The conversion according to predetermined conditions is, for example, conversion of a measurement acquired value at each point to a color value, using a conversion table having color values of pixels and ranges of measurement acquired values in association with each other. Furthermore, the conversion to a color value according to predetermined conditions may be conversion using a conversion formula or the like performing similar conversion. For example, the conversion may be made such that the color of each pixel is proportional to the measurement acquired value corresponding to each pixel. The color value of each pixel in a cross-sectional image indicates, for example, a measurement acquired value such as the tracer accumulation amount or concentration in the cross-section of the living body acquired at a point corresponding to that pixel, and, thus, the color value of each pixel may be considered as being associated with the measurement acquired value corresponding to that pixel. Accordingly, the measurement acquired value corresponding to each pixel can be acquired from the color value of that pixel.

Furthermore, in the cross-sectional image storage unit 11, information in which each pixel in a cross-sectional image, a measurement acquired value corresponding to that pixel, and the like, are associated with the cross-sectional image (hereinafter, referred to as “measurement acquired value management information”), may be stored. For example, the measurement acquired value management information is information in which a cross-sectional image, the coordinates of pixels forming the cross-sectional image, and measurement acquired values corresponding to the respective pixels are associated with each other. The measurement acquired value corresponding to each pixel is a measurement acquired value in a cross-section of a living body acquired at each point corresponding to each pixel. If such measurement acquired value management information is used, the measurement acquired value corresponding to each pixel in a cross-sectional image can be acquired.

In the cross-sectional image storage unit 11, multiple cross-sectional images are stored in association with cross-sectional image identifying information, which is information for identifying each cross-sectional image. For example, information having a cross-sectional image and cross-sectional image identifying information is stored in the cross-sectional image storage unit 11 and the like. The cross-sectional image identifying information may be any information with which a cross-sectional image can be identified. For example, the cross-sectional image identifying information may be identifying information inherent in each cross-sectional image. The cross-sectional image identifying information may be considered, for example, as information obtained by combining information for identifying a living body and information indicating the acquisition position of a cross-sectional image.

The value obtained by modifying the measured value is a value obtained by performing predetermined modification on the measured value that has been acquired at each point by an image capturing apparatus or the like. For example, the value obtained by modifying the measured value may be a value obtained by modifying the measured value based on the amount of tracer administered, the body weight of a test subject, or the like, or may be a value obtained by modifying the measured value so as to eliminate variation between image capturing apparatuses. Furthermore, the value obtained by modifying the measured value may be a value obtained by performing predetermined processing such as modification, standardization, or normalization on the measured value. For example, in a PET image or a SPECT image, the value obtained by modifying the measured value is typically a so-called standardized uptake value (SUV), which is a value obtained by standardizing the measured value (value indicating the tracer accumulation amount) that has been acquired at each point by an image capturing apparatus, based on the amount of tracer administered and the body weight of a test subject.

Instead of a cross-sectional image in which the measurement acquired value is replaced by a color value, a cross-sectional image in which distribution of pixels corresponding to measurement acquired values in the same value range is expressed as contour lines may be stored in the cross-sectional image storage unit 11. The process that acquires a cross-sectional image of a living body is a known art, and, thus, a detailed description thereof has been omitted.

The cross-sectional image storage unit 11 is preferably a non-volatile storage medium, but may be realized also by a volatile storage medium. Note that the same is applied to other storage units.

The operation accepting unit 12 accepts an operation that specifies a cross-sectional image stored in the cross-sectional image storage unit 11. The operation that specifies a cross-sectional image is, for example, an operation that inputs cross-sectional image identifying information of that cross-sectional image, an operation that inputs information indicating the acquisition position or the arrangement order of that cross-sectional image, or an operation that selects a file or the like of that cross-sectional image using a mouse or the like. The cross-sectional image specified by this cross-sectional image specifying operation is referred to as a specified cross-sectional image, in this example. If settings are made to read a cross-sectional image predetermined by default or the like in response to a predetermined operation (e.g., an operation that starts the image processing apparatus 1) or the like, accepting of this predetermined operation may be considered as accepting of the operation that specifies a cross-sectional image. Furthermore, the operation accepting unit 12 may further accept an operation that changes the specified cross-sectional image. The operation that changes the specified cross-sectional image is, for example, an operation that specifies a cross-sectional image different from the cross-sectional image specified immediately previously.

The accepting an operation in this example is a concept that encompasses accepting of information input from an input device such as a keyboard, a mouse, or a touch panel, receiving of information transmitted via a wired or wireless communication line, and accepting of information read from a storage medium such as an optical disk, a magnetic disk, or a semiconductor memory. The operation may be input through any means such as a numeric keypad, a keyboard, a mouse, a menu screen, and the like. The operation accepting unit 12 is realized by a device driver for input means such as a numeric keypad or a keyboard, or control software for a menu screen, for example. The same is applied to the region-of-interest operation accepting unit 13.

The region-of-interest operation accepting unit 13 accepts an operation that sets a region of interest in a cross-sectional image (specified cross-sectional image) specified by the operation that is accepted by the operation accepting unit 12. The region of interest (ROI) is, for example, a region that is of interest to the user, in the cross-sectional image. The region of interest may be considered as a region that is to be observed or monitored. One region of interest may be configured by non-continuous regions. The non-continuous regions are multiple regions each of which is configured by one pixel or two or more adjacent pixels in the cross-sectional image, wherein pixels forming different regions are not in contact with each other.

The operation that sets a region of interest, accepted by the region-of-interest operation accepting unit 13, is, for example, an operation that specifies a region as the region of interest in the cross-sectional image. For example, the region-of-interest operation accepting unit 13 accepts, for each of one or more regions of interest that are to be set by the user, an operation that specifies a region in a cross-sectional image specified by the operation that is accepted by the operation accepting unit 12. The operation that specifies a region is, for example, an operation that specifies the contour of a region configured by pixels in the cross-sectional image. Examples thereof include an operation that specifies pixels in a rectangle, a circle, or any free shape forming the contour of a region, or an operation that specifies pixels at the vertices of a polygon forming the contour. The operation that specifies the contour may be an operation that specifies a border line forming the contour between pixels. Furthermore, the operation that specifies a region may be an operation that specifies, with a cursor or the like, pixels that are to be included in a region of interest, from among pixels forming a cross-sectional image.

Furthermore, for example, the region-of-interest operation accepting unit 13 may accept, for each region of interest, an operation that specifies one or more regions that the user wants to set as the region of interest, from among one or more regions set in advance in the cross-sectional image. The multiple non-continuous regions set in advance may be regions specified by the above-described operation that is accepted by the operation accepting unit 12, or may be one or more regions set by automatically selecting, as the non-continuous regions, groups of continuous pixels each having the pixel color value or the measurement acquired value associated therewith that is a predetermined threshold or more, from the cross-sectional image.

For example, the region-of-interest operation accepting unit 13 accepts an operation that changes the region of interest. The region-of-interest operation accepting unit 13 accepts an operation that changes the region of interest set in a cross-sectional image. The operation that changes the region of interest is, for example, an operation that changes one or more of the position, the size, and the shape of the region of interest. The operation that changes the region of interest is, for example, an operation that changes the shape, the size, or the position of the contour of the region of interest, an operation that reduces pixels included in the region of interest, or an operation that adds new pixels to the region of interest.

It is preferable that a cross-sectional image specified by the operation that is accepted by the operation accepting unit 12 is displayed by the display unit 19 (described later) on an unshown monitor or the like, and that the region-of-interest operation accepting unit 13 accepts an operation that specifies a region of interest or an operation that changes a region of interest, on this displayed cross-sectional image.

The region-of-interest setting information accumulating unit 14 acquires region-of-interest setting information, which is information for setting one or more regions of interest in a specified cross-sectional image, and accumulates the acquired information in the region-of-interest setting information storage unit 15 (described later). The region-of-interest setting information may be considered as information defining a region of interest. The region-of-interest setting information is, for example, information collectively having a group of pieces of information (e.g., coordinate values) for identifying all pixels included in a region of interest. Furthermore, the region-of-interest setting information may have information indicating the contour of a region of interest. The information indicating the contour is, for example, information for identifying one or more pixels indicating the contour of a region of interest. Alternatively, the information indicating the contour may be information indicating a border line between a region of interest and the other regions. The region-of-interest setting information accumulating unit 14 may accumulate region-of-interest setting information, and information for identifying a region of interest indicated by the region-of-interest setting information. The information for identifying a region of interest is, for example, produced according to a predetermined rule or the like. Furthermore, information for identifying a cross-sectional image in which a region of interest is to be set may be acquired. For example, the region-of-interest setting information accumulating unit 14 may acquire management information having the region-of-interest setting information, and at least one of the information for identifying a region of interest indicated by the region-of-interest setting information and the information for identifying a cross-sectional image in which the region of interest is set.

For example, the region-of-interest setting information accumulating unit 14 acquires and accumulates region-of-interest setting information for setting, as a region of interest, the region indicated by the operation that is accepted by the region-of-interest operation accepting unit 13. Furthermore, the region-of-interest setting information accumulating unit 14 may automatically select, as a region of interest, a group of pixels each having the pixel color value or the measurement acquired value associated therewith that is a predetermined threshold or more, from the specified cross-sectional image, and acquire and accumulate region-of-interest setting information indicating this region of interest.

The region-of-interest setting information accumulating unit 14 may acquire region-of-interest setting information for setting a region of interest changed according to the operation that changes the region of interest, accepted by the region-of-interest operation accepting unit 13, and accumulate this region-of-interest setting information in the region-of-interest setting information storage unit 15. For example, the region-of-interest setting information accumulating unit 14 updates region-of-interest setting information before change, accumulated in the region-of-interest setting information storage unit 15, to region-of-interest setting information for setting a region of interest after change. The region-of-interest setting information accumulating unit 14 may delete the region-of-interest setting information before change, or may accumulate this information in an unshown storage medium or the like for the sake of redoing the processing.

Furthermore, if the operation accepting unit 12 accepts an operation that changes the specified cross-sectional image, the region-of-interest setting information accumulating unit 14 may acquire, for the specified cross-sectional image after change, the same region-of-interest setting information as that of the specified cross-sectional image before change, and accumulate this region-of-interest setting information in the region-of-interest setting information storage unit 15. The same region-of-interest setting information is region-of-interest setting information for setting the region of interest having the same position, size, and shape. For example, the region-of-interest setting information accumulating unit 14 may acquire the region-of-interest setting information before change, as it is, as the region-of-interest setting information for the specified cross-sectional image after change.

The region-of-interest setting information accumulating unit 14 may be realized typically by an MPU, a memory, or the like. Typically, the processing procedure of the region-of-interest setting information accumulating unit 14 is realized by software, and the software is stored in a storage medium such as a ROM. Note that the processing procedure may be realized also by hardware (a dedicated circuit).

In the region-of-interest setting information storage unit 15, one or more pieces of region-of-interest setting information are stored. In the region-of-interest setting information storage unit 15, for example, the region-of-interest setting information acquired by the region-of-interest setting information accumulating unit 14 may be accumulated. Furthermore, in the region-of-interest setting information storage unit 15, the region-of-interest setting information may be accumulated in advance. Furthermore, one or more pieces of region-of-interest setting information read from among the region-of-interest setting information stored in advance in an unshown storage unit or the like may be temporarily stored. In the region-of-interest setting information storage unit 15, the region-of-interest setting information, and at least one of the information for identifying a region of interest indicated by the region-of-interest setting information and the information for identifying a cross-sectional image in which the region of interest indicated by this region-of-interest setting information is set may be accumulated in association with each other. It is sufficient that, in the region-of-interest setting information storage unit 15, at least the region-of-interest setting information for setting one or more regions of interest in a specified cross-sectional image is stored. The storing in this example is a concept that encompasses temporarily storing. For example, the region-of-interest setting information indicating the region indicated by the operation that is accepted by the region-of-interest operation accepting unit 13 may be acquired by the region-of-interest setting information accumulating unit 14, and this region-of-interest setting information may be temporarily stored by the region-of-interest setting information accumulating unit 14 in the region-of-interest setting information storage unit 15. The region-of-interest setting information storage unit 15 may be realized by a non-volatile storage medium or a volatile storage medium.

The evaluation value acquiring unit 16 acquires, using the measured values, an evaluation value, which is a value for evaluating a region of interest in the specified cross-sectional image, for each region of interest indicated by the region-of-interest setting information, and acquires, using the measured values, a related evaluation value, which is a value for evaluating a region in one or more cross-sectional images other than the specified cross-sectional image, for each region corresponding to each region of interest indicated by the region-of-interest setting information.

First, processing will be described in which the evaluation value acquiring unit 16 acquires an evaluation value, which is a value for evaluating a region of interest in the specified cross-sectional image, for each region of interest indicated by the region-of-interest setting information.

The evaluation value is a value for evaluating each region of interest. The evaluation value may be considered as a value used by the user for evaluating each region of interest. The evaluation in this example is, for example, to judge whether or not each region of interest is a region of interest including a lesion portion. The measured value is a value obtained by measurement performed in order to obtain the cross-sectional image. For example, in a PET image, the measured value is the concentration or the accumulation amount of tracer or the like. The acquiring an evaluation value using the measured values is, for example, acquiring an evaluation value using the measured values corresponding to the respective pixels in the region of interest. The acquiring an evaluation value using the measured values is, for example, a concept that encompasses acquiring an evaluation value using values obtained by modifying the measured values, and acquiring an evaluation value using color values of pixels corresponding to the measured values. The acquiring an evaluation value using the measured values is, for example, acquiring an evaluation value using the above-described measurement acquired values, that is, the measured values, the values obtained by modifying the measured values, or the like. For example, the evaluation value acquiring unit 16 acquires an evaluation value using the measurement acquired values corresponding to the pixels included in each region of interest. The evaluation value is, for example, the average, the maximum, the minimum, the standard deviation, or the like of the measurement acquired values corresponding to the pixels included in each region of interest. Furthermore, since the color value of each pixel in the cross-sectional image corresponds to the evaluation value, the evaluation value may be the average, the maximum, the minimum, the standard deviation, or the like of the color values of pixels included in each region of interest. What type of evaluation value is to be acquired may be determined based on what type of measurement was performed in order to acquire the measurement acquired value, what type of evaluation is to be performed by the user, or the like. Furthermore, two or more different types of evaluation values may be acquired from one region of interest.

For example, the evaluation value acquiring unit 16 acquires an evaluation value using the measurement acquired values corresponding to one or more pixels included in each region of interest. The measurement acquired values corresponding to the pixels are, for example, measurement acquired values corresponding to the color values of the respective pixels, or measurement acquired values corresponding to the respective pixels. The state in which the respective pixels and the measurement acquired values correspond to each other is, for example, the state in which measurement acquired value management information in which each cross-sectional image, the coordinates of each pixel, and the measurement acquired value are associated with each other is accumulated in an unshown storage medium or the like. The acquiring an evaluation value using the measurement acquired values corresponding to the pixels is, for example, acquiring measurement acquired values corresponding to the color values of the pixels included in each region of interest and acquiring an evaluation value using the measurement acquired values, acquiring measurement acquired values associated with the pixels included in each region of interest (specifically, associated with the coordinates of the pixels) and acquiring an evaluation value using the measurement acquired values.

For example, in order to acquire the measurement acquired values corresponding to the color values of the pixels included in each region of interest and then acquire an evaluation value using the measurement acquired values, first, the evaluation value acquiring unit 16 acquires a measurement acquired value corresponding to the color value of each pixel, for example, from information prepared in advance in which the color value of each pixel in a cross-sectional image, and the measurement acquired value indicating the amount or the concentration of tracer or the like accumulated are associated with each other. This information may be a conversion table similar to that used to acquire the color value of a pixel from the measurement acquired value. Alternatively, the evaluation value acquiring unit 16 may acquire a measurement acquired value, from the color value of each pixel, using an arithmetic expression or the like prepared in advance and showing the corresponding relationship between the color of each pixel and a measurement acquired value. The arithmetic expression may be a conversion formula that performs inverse conversion of the conversion performed by the conversion formula in order to calculate the color value of a pixel from the measurement acquired value. If the color value of a pixel is proportional to the measurement acquired value, the evaluation value acquiring unit 16 may acquire a measurement acquired value proportional to the color value of each pixel. The thus acquired measurement acquired values of the pixels forming each region of interest are used to acquire an evaluation value (e.g., the maximum of the measurement acquired values, etc.) for that region of interest.

Furthermore, if the measurement acquired value management information has respective pixels in a cross-sectional image and measurement acquired values in association with each other, the evaluation value acquiring unit 16 may acquire measurement acquired values associated with the pixels included in each region of interest, and acquire an evaluation value such as the maximum using the measurement acquired values. For example, if the measurement acquired value management information having the coordinates of respective pixels forming a cross-sectional image and measurement acquired values in association with each other is stored in the cross-sectional image storage unit 11, the evaluation value acquiring unit 16 acquires, for each region of interest, measurement acquired values corresponding to the coordinates of the pixels included in each region of interest, from the measurement acquired value management information. The measurement acquired values acquired for each region of interest are used to acquire an evaluation value (e.g., the maximum of the measurement acquired values, etc.) for that region of interest.

If the cross-sectional image is a PET image or the like, for example, the evaluation value acquiring unit 16 acquires an evaluation value using an SUV, which is a measurement acquired value associated with each pixel included in a region of interest. In a PET image, typically, the maximum of the SUVs respectively corresponding to multiple pixels included in each region of interest is used as the evaluation value of the region of interest.

Next, processing will be described in which the evaluation value acquiring unit 16 acquires, using the measured values, a related evaluation value, which is a value for evaluating a region in one or more cross-sectional images other than the specified cross-sectional image, for each region corresponding to each region of interest indicated by the region-of-interest setting information.

The one or more cross-sectional images other than the specified cross-sectional image are one or more cross-sectional images other than the specified cross-sectional image stored in the cross-sectional image storage unit 11. The one or more cross-sectional images other than the specified cross-sectional image are specifically one or more cross-sectional images acquired at one or more positions different from the acquisition position of the specified cross-sectional image, in a predetermined direction of the same living body as the living body from which the specified cross-sectional image is acquired. For example, they are cross-sectional images associated with the information for identifying the same living body as the living body from which the specified cross-sectional image is acquired.

The one or more cross-sectional images other than the specified cross-sectional image may be all cross-sectional images of the one or more cross-sectional images acquired from the same living body as the living body from which the specified cross-sectional image is acquired, or may be part of these cross-sectional images. The part of the cross-sectional images are, for example, cross-sectional images in a number specified by default or by the user, or cross-sectional images whose number is in a predetermined proportion relative to the total number of cross-sectional images.

The one or more cross-sectional images other than the specified cross-sectional image may be cross-sectional images in a range specified by the user. The information specifying the range that has been input may be accepted by, for example, the operation accepting unit 12 or the like. The information specifying the range in this example may be, for example, information having information for identifying a cross-sectional image as the start position of the range and information for identifying a cross-sectional image as the end position, or may be information having information for identifying a cross-sectional image as the start position or the end position and information indicating the number of cross-sectional images (including the specified cross-sectional image) included in the range. Furthermore, this information may be information specifying the number of cross-sectional images before and after the specified cross-sectional image, or may be information specifying the number of cross-sectional images within the range in the case where the specified cross-sectional image is set at a predetermined position (e.g., set at the center of the range).

The one or more cross-sectional images other than the specified cross-sectional image are, for example, one or more cross-sectional images whose arrangement order is close to that of the specified cross-sectional image.

It is preferable that the one or more cross-sectional images other than the specified cross-sectional image are one or more cross-sectional images whose arrangement order is consecutive with that of the specified cross-sectional image. That is to say, it is preferable that the evaluation value acquiring unit 16 acquires a related evaluation value in one or more cross-sectional images whose arrangement order is consecutive with that of the specified cross-sectional image.

Furthermore, the one or more cross-sectional images other than the specified cross-sectional image may be one or more cross-sectional images whose arrangement order is either before or after the specified cross-sectional image, or may be two or more cross-sectional images before and after the specified cross-sectional image. In this example, the terms before and after respectively refer to those in the order with respect to the predetermined direction. For example, the one or more cross-sectional images other than the specified cross-sectional image acquired by the evaluation value acquiring unit 16 are cross-sectional images in a predetermined number consecutively arranged before and after the specified cross-sectional image.

Each region corresponding to each region of interest indicated by the region-of-interest setting information is, for example, a region in the cross-sectional image having the same size, position, and shape as those of the region of interest indicated by the region-of-interest setting information. In this example, the position may be considered as a relative position (coordinates) in the cross-sectional image. Each region in the cross-sectional image corresponding to each region of interest indicated by the region-of-interest setting information may be such that the size is continuously or stepwise reduced as the acquisition position of this cross-sectional image is away from the acquisition position of the specified cross-sectional image. With this configuration, whether or not the region of interest set in the specified cross-sectional image is at the center of a lesion can be more reliably judged.

The related evaluation value is a value for evaluating each region corresponding to the region of interest, in one or more cross-sectional images other than the specified cross-sectional image, and is a value that is the same as the above-described evaluation value, except that these cross-sectional images are different from the specified cross-sectional image, and that the regions from which the values are acquired are regions corresponding to the region of interest. For example, if the cross-sectional image is a PET image, the related evaluation value is the maximum of the SUVs corresponding to the pixels in the region. The evaluation value acquiring unit 16 acquires a related evaluation value in each region corresponding to the region of interest, in one or more cross-sectional images other than the specified cross-sectional image, as in the case of the evaluation value. The process that acquires a related evaluation value in each region using the measured values is similar to the above-described process that acquires an evaluation value in each region of interest, and, thus, a detailed description thereof has been omitted. In this example, the acquiring using the measured values is a concept that encompasses, for example, acquiring a related evaluation value using values obtained by modifying the measured values, and acquiring a related evaluation value using color values of pixels corresponding to the measured values, as in the case of acquiring an evaluation value.

Furthermore, for example, if the region-of-interest setting information accumulating unit 14 acquires region-of-interest setting information of the region of interest changed according to the operation that is accepted by the region-of-interest operation accepting unit 13 or the like, and accumulates this information (e.g., uses this information to update the information) in the region-of-interest setting information storage unit 15, the evaluation value acquiring unit 16 acquires an evaluation value and a related evaluation value for the region of interest after change. For example, the evaluation value acquiring unit 16 acquires an evaluation value and a related evaluation value for the region of interest after change, using the updated region-of-interest setting information stored in the region-of-interest setting information storage unit 15. That is to say, the evaluation value acquiring unit 16 acquires an evaluation value in the region of interest after change in the specified cross-sectional image, and acquires a related evaluation value in each region corresponding to the region of interest after change, in one or more cross-sectional images other than the specified cross-sectional image. The region of interest after change is, for example, a region of interest indicated by the region-of-interest setting information that is acquired by the region-of-interest setting information accumulating unit 14 for the region of interest subjected to the change operation and is stored in the region-of-interest setting information storage unit 15.

Furthermore, for example, it is preferable that, if the specified cross-sectional image is changed according to the operation that is accepted by the operation accepting unit 12, the evaluation value acquiring unit 16 acquires an evaluation value and a related evaluation value in the specified cross-sectional image after change and one or more cross-sectional images other than the specified cross-sectional image. That is to say, the evaluation value acquiring unit 16 acquires an evaluation value in each region of interest in the specified cross-sectional image after change, and acquires a related evaluation value in each region corresponding to each region of interest, in one or more cross-sectional images other than the specified cross-sectional image after change.

The evaluation value acquiring unit 16 accumulates the thus acquired evaluation value and one or more related evaluation values in an unshown storage medium or the like, respectively in association with the specified cross-sectional image and the one or more cross-sectional images in which these values are acquired. The evaluation value acquiring unit 16 accumulates, for example, information having an evaluation value and a related evaluation value, and information for identifying a specified cross-sectional image and a cross-sectional image in which these values are acquired. Alternatively, the evaluation value acquiring unit 16 may accumulate the thus acquired evaluation value and one or more related evaluation values, for each region of interest, in an unshown storage medium or the like, respectively in association with the specified cross-sectional image and the one or more cross-sectional images in which these values are acquired. The evaluation value acquiring unit 16 accumulates, for example, information having information for identifying a region of interest, an evaluation value and a related evaluation value, and information for identifying a specified cross-sectional image and a cross-sectional image in which these values are acquired. The evaluation value acquiring unit 16 may be realized typically by an MPU, a memory, or the like. Typically, the processing procedure of the evaluation value acquiring unit 16 is realized by software, and the software is stored in a storage medium such as a ROM. Note that the processing procedure may be realized also by hardware (a dedicated circuit).

The output unit 17 outputs an evaluation value and a related evaluation value acquired by the evaluation value acquiring unit 16 in association with the specified cross-sectional image corresponding to the evaluation value and the cross-sectional image corresponding to the related evaluation value. For example, the output unit 17 outputs information having an evaluation value and a related evaluation value acquired by the evaluation value acquiring unit 16, and information for identifying a specified cross-sectional image and a cross-sectional image in which these values are acquired. Alternatively, the output unit 17 may output an evaluation value and a related evaluation value acquired by the evaluation value acquiring unit 16, for each region of interest, in association with the specified cross-sectional image corresponding to the evaluation value and the cross-sectional image corresponding to the related evaluation value. For example, the output unit 17 may output information having information for identifying a region of interest, an evaluation value and a related evaluation value acquired by the evaluation value acquiring unit 16, and information for identifying a specified cross-sectional image and a cross-sectional image in which these values are acquired.

The output unit 17 outputs an evaluation value and a related evaluation value, for example, in the form of a bar graph. For example, a bar graph is output in which the values of an evaluation value and a related evaluation value are indicated by the lengths of bars. The output unit 17 outputs, for example, a bar graph in which bars indicating an evaluation value and a related evaluation value are arranged according to the arrangement order of the specified cross-sectional image and the cross-sectional image corresponding to the evaluation value and the related evaluation value. If the cross-sectional images are cross-sectional images perpendicular to the height direction, acquired at different positions in the height direction of the living body (e.g., the body height direction of the living body), the bar graph is preferably such that the bar length direction is set in the horizontal direction, and the bars are arranged in the vertical direction according to the arrangement order of the specified cross-sectional image and the cross-sectional image, because height positions of the bars in the graph correspond to the positions in the height direction of the living body, and the relationship between the values in the graph and the height positions in the living body can be easily seen. Furthermore, the output unit 17 may output an evaluation value and a related evaluation value using a graph other than a bar graph, or as color brightness, color tone, or numerical values. For example, the output unit 17 may output maximums of SUVs, which are an evaluation value and a related evaluation value, as numerical values. The output unit 17 may output an evaluation value and a related evaluation value using multiple display forms in combination, such as output using both a bar graph and numerical values. That is to say, the output unit 17 may output an evaluation value and a related evaluation value using at least one of various graphs including bar graph, color brightness, color tone, and numerical values. Furthermore, a bar in a graph or a numerical value showing the maximum may be displayed in a reversed color.

The output unit 17 may perform output such that the specified cross-sectional image or the cross-sectional image associated with the evaluation value or the related evaluation value with the highest evaluation is emphasized. The output unit 17 may perform output such that, for each region of interest, the specified cross-sectional image or the cross-sectional image associated with the evaluation value or the related evaluation value with the highest evaluation is emphasized. The output in which the specified cross-sectional image or the cross-sectional image is emphasized is output performed such that the information for identifying the specified cross-sectional image or the cross-sectional image, the image corresponding to the specified cross-sectional image or the cross-sectional image, or the like is emphasized. The emphasized output is output in which the evaluation value or the related evaluation value with the highest evaluation is output in a different manner from that of the other evaluation values or related evaluation values. The output manner is, for example, the color, the shape, the pattern, the size, or the contour color of characters or graphics, the color or the pattern of the background, or the like. If the output is the displaying, the output manner may be considered as a display manner. For example, if a bar graph is displayed as described above, the output performed such that the specified cross-sectional image or the cross-sectional image associated with the evaluation value or the related evaluation value with the highest evaluation is emphasized is the displaying in which a bar indicating the evaluation value with the highest evaluation is displayed in a different manner from that of the other bars (e.g., displayed as a bar having a color different from the others). Accordingly, which cross-sectional image includes the specified cross-sectional image or the cross-sectional image associated with the evaluation value or the related evaluation value with the highest evaluation can be judged, and, thus, a useful clue can be provided for the user to judge whether or not the related regions are set at proper positions. The evaluation value or the related evaluation value with the highest evaluation is, for example, the evaluation value or the related evaluation value having a value indicating that a lesion has progressed furthest if the evaluation is to evaluate whether or not the lesion has progressed. Furthermore, the evaluation value or the related evaluation value with the highest evaluation is, for example, the evaluation value or the related evaluation value having a value indicating that the evaluated portion is the most normal if the evaluation is to evaluate whether or not the portion is normal. If the evaluation value is a value that increases as the evaluation is higher, the evaluation value with the highest evaluation is, for example, the largest evaluation value. On the other hand, if the evaluation value is a value that decreases as the evaluation is higher, the evaluation value with the highest evaluation is, for example, the smallest evaluation value.

The output described in this example is a concept that encompasses displaying on a display screen, projection using a projector, printing with a printer, transmission to an external apparatus, accumulation in a storage medium, delivery of a processing result to another processing apparatus or another program, and the like.

The output unit 17 may be considered to include or not to include an output device such as a display screen. The output unit 17 may be realized, for example, by driver software for an output device, a combination of driver software for an output device and the output device, or the like.

The region-of-interest setting information output unit 18 outputs the region-of-interest setting information stored in the region-of-interest setting information storage unit 15. The region-of-interest setting information output unit 18 outputs, for example, the region-of-interest setting information acquired and accumulated by the region-of-interest setting information accumulating unit 14. The region-of-interest setting information output unit 18 outputs, for example, the region-of-interest setting information according to an instruction accepted via the operation accepting unit 12 or the like. For example, the region-of-interest setting information output unit 18 may output information in which the region-of-interest setting information is associated with at least one of the information for identifying a region of interest and the information for identifying a cross-sectional image in which the region of interest is set. The output described in this example is a concept that encompasses transmission to an external apparatus, accumulation in a storage medium, delivery of a processing result to another processing apparatus or another program, and the like. For example, the region-of-interest setting information output unit 18 accumulates the region-of-interest setting information in a storage unit (not shown) in which the region-of-interest setting information is to be stored. This storage unit is realized, for example, by a storage medium or the like. If the region-of-interest setting information stored in the region-of-interest setting information storage unit 15 is used as the region-of-interest setting information of the region of interest in each cross-sectional image finally set by the image processing apparatus 1, the region-of-interest setting information output unit 18, this output process, and the like may be omitted.

The region-of-interest setting information output unit 18 may be considered to include or not to include an output device. The region-of-interest setting information output unit 18 may be realized, for example, by driver software for an output device, a combination of driver software for an output device and the output device, or the like.

The display unit 19 displays, on an unshown monitor or the like, the cross-sectional image stored in the cross-sectional image storage unit 11. For example, the display unit 19 displays the specified cross-sectional image. The display unit 19 may display a cross-sectional image such as the specified cross-sectional image in a region different from that on the same monitor to which the output unit 17 outputs the evaluation value or the related evaluation value. Furthermore, the display unit 19 may display, on the cross-sectional image, the region of interest indicated by the region-of-interest setting information stored in the region-of-interest setting information storage unit 15. The display unit 19 may be considered to include or not to include a display device. The display unit 19 may be realized, for example, by driver software for a display device, a combination of driver software for a display device and the display device, or the like.

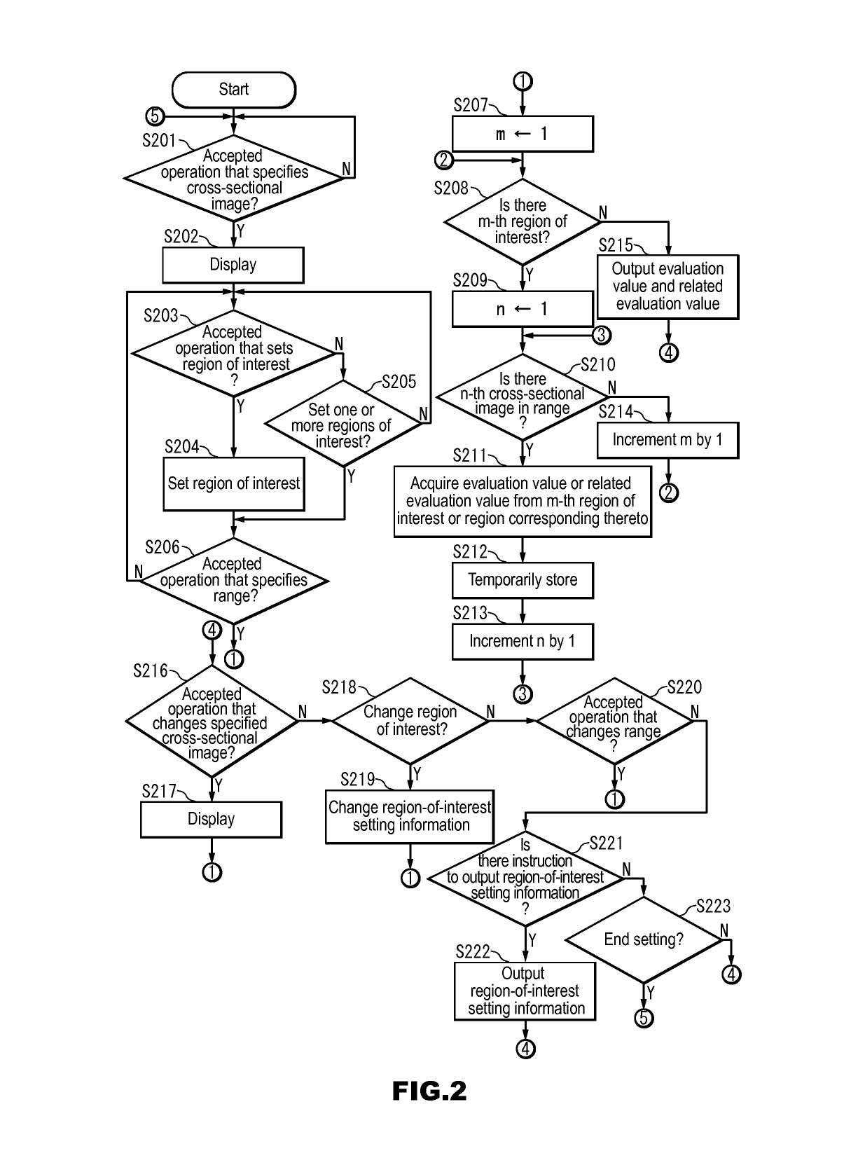

Next, the operation of the image processing apparatus 1 will be described with reference to the flowchart in FIG. 2.

(Step S201) It is judged whether or not the operation accepting unit 12 has accepted an operation that specifies a cross-sectional image stored in the cross-sectional image storage unit 11. If accepted, the procedure advances to step S202, and, if not, the procedure returns to step S201.

(Step S202) The display unit 19 displays the cross-sectional image specified in step S201. This cross-sectional image is the specified cross-sectional image.

(Step S203) It is judged whether or not the region-of-interest operation accepting unit 13 has accepted an operation that sets a region of interest in the specified cross-sectional image. If accepted, the procedure advances to step S204, and, if not, the procedure advances to step S205.

(Step S204) The region-of-interest setting information accumulating unit 14 acquires region-of-interest setting information for setting the region of interest indicated by the operation accepted in step S203. The acquired region-of-interest setting information is accumulated in the region-of-interest setting information storage unit 15. The procedure advances to step S206.

(Step S205) The region-of-interest setting information accumulating unit 14 judges whether or not one or more regions of interest have been set. For example, it is judged whether or not one or more pieces of region-of-interest setting information have been stored in the region-of-interest setting information storage unit 15, and, if stored, it is judged that one or more regions of interest have been set, and, if not, it is judged that one or more regions of interest have not been set. If one or more regions of interest have been set, the procedure advances to step S206, and, if not, the procedure returns to step S203.

(Step S206) It is judged whether or not the operation accepting unit 12 has accepted an operation that specifies the range of cross-sectional images in which an evaluation value and a related evaluation value are to be acquired for each region of interest. It is herein assumed that the specified cross-sectional image is also a cross-sectional image. If the operation that specifies the range has been accepted, the procedure advances to step S207, and, if not, the procedure returns to step S203.

(Step S207) The evaluation value acquiring unit 16 substitutes 1 for a counter m.

(Step S208) The evaluation value acquiring unit 16 judges whether or not an m-th region of interest has been set in the specified cross-sectional image. For example, it is judged whether or not there is an m-th piece of region-of-interest setting information in the region-of-interest setting information accumulated in the region-of-interest setting information storage unit 15 in step S204, and, if there is, it is judged that this region of interest has been set, and, if not, it is judged that this region of interest has not been set. If this region of interest has been set, the procedure advances to step S209, and, if not, the procedure advances to step S215.

(Step S209) The evaluation value acquiring unit 16 substitutes 1 for a counter n.

(Step S210) The evaluation value acquiring unit 16 judges whether or not there is an n-th cross-sectional image in the cross-sectional images in the range set in step S206. It is herein assumed that the specified cross-sectional image is also a cross-sectional image. If there is, the procedure advances to step S211, and, if not, the procedure advances to step S214.

(Step S211) The evaluation value acquiring unit 16 acquires a related evaluation value from a region corresponding to the m-th region of interest, in the n-th cross-sectional image. If the n-th cross-sectional image is the specified cross-sectional image, an evaluation value is acquired from the m-th region of interest.

(Step S212) The evaluation value acquiring unit 16 temporarily stores the related evaluation value acquired in step S211, in association with information for identifying the n-th cross-sectional image, in an unshown storage medium or the like. If the n-th cross-sectional image is the specified cross-sectional image, the evaluation value acquired in step S211 and information for identifying the specified cross-sectional image are temporarily stored in association with each other.

(Step S213) The evaluation value acquiring unit 16 increments the counter n by 1. The procedure returns to step S210.

(Step S214) The evaluation value acquiring unit 16 increments the counter m by 1. The procedure returns to step S208.

(Step S215) The output unit 17 outputs the evaluation value and the related evaluation value temporarily stored in step S212 in association with the information for identifying the cross-sectional image and the information for identifying the specified cross-sectional image, for example on an unshown monitor or the like.

(Step S216) It is judged whether or not the operation accepting unit 12 has accepted an operation that changes the specified cross-sectional image. If accepted, the procedure advances to step S217, and, if not, the procedure advances to step S218.

(Step S217) The display unit 19 displays the specified cross-sectional image indicated by the operation accepted in step S216. For example, the specified cross-sectional image displayed immediately previously is updated to the specified cross-sectional image indicated by the operation accepted in step S216. The procedure advances to step S207. It is herein assumed that the region of interest set in the specified cross-sectional image displayed immediately previously is the region of interest in the specified cross-sectional image after change. For example, the region-of-interest setting information set for the immediately previous specified cross-sectional image is used as the region-of-interest setting information for the specified cross-sectional image after change.

(Step S218) It is judged whether or not the region-of-interest operation accepting unit 13 has accepted an operation that changes the region of interest set in the specified cross-sectional image. If accepted, the procedure advances to step S219, and, if not, the procedure advances to step S220.

(Step S219) The region-of-interest setting information accumulating unit 14 changes the region-of-interest setting information according to the operation accepted in step S218. Specifically, the region-of-interest setting information accumulating unit 14 updates the region-of-interest setting information stored in association with the current specified cross-sectional image in the region-of-interest setting information storage unit 15, to region-of-interest setting information that the user wants to set. For example, the region-of-interest setting information accumulating unit 14 changes the region-of-interest setting information such that the region of interest has the size, the shape, and the position indicated by the operation accepted in step S218. Accordingly, the size, the shape, the position, or the like of the region of interest is changed. After step S219, the processing from step S208 to step S214 may be performed only on the region of interest that has been changed. The output of the evaluation value and the related evaluation value only in the region of interest that has been changed may be updated in step S215.

(Step S220) It is judged whether or not the operation accepting unit 12 has accepted an operation that changes the range of cross-sectional images (i.e., the range of the arrangement order of cross-sectional images) in which an evaluation value and a related evaluation value are to be acquired for each region of interest. If accepted, the procedure returns to step S207, and, if not, the procedure advances to step S221.

(Step S221) It is judged whether or not the operation accepting unit 12 has accepted an operation that gives an instruction to output the region-of-interest setting information stored in the region-of-interest setting information storage unit 15. If accepted, the procedure advances to step S222, and, if not, the procedure advances to step S223.

(Step S222) The region-of-interest setting information output unit 18 outputs the region-of-interest setting information stored in the region-of-interest setting information storage unit 15. For example, the information is accumulated in an unshown region-of-interest setting information storage unit or the like. The procedure returns to step S216.

(Step S223) The operation accepting unit 12 judges whether or not to end the process that sets a region of interest in the currently displayed specified cross-sectional image. For example, it is judged whether or not the operation accepting unit 12 has accepted an operation that ends the setting process. In the case of ending the process, display of the currently displayed specified cross-sectional image is ended, and the procedure returns to step S201, and, in the case of not ending the process, the procedure returns to step S216.

Note that the process is terminated by powering off or an interruption at completion of the process in the flowchart in FIG. 2.

Hereinafter, a specific operation of the image processing apparatus 1 in this embodiment will be described. It is herein assumed that, in the cross-sectional image storage unit 11, multiple PET images captured along cross-sections perpendicular to the body height direction while shifting at predetermined intervals in the abdominal part of a patient from the head side to the leg side are stored as cross-sectional images. For example, it is assumed that the color value (e.g., the hue value, the brightness value, etc.) of each pixel in a cross-sectional image is set as a value proportional to a standard uptake value (SUV), which is a value obtained by modifying the measured value of the tracer concentration in the living body. In this example, the SUV corresponds to the above-described measurement acquired value. It is assumed that measurement acquired value management information, which is information having the coordinates of each pixel in a cross-sectional image and an SUV that is the measurement acquired value is further stored in the cross-sectional image storage unit 11.

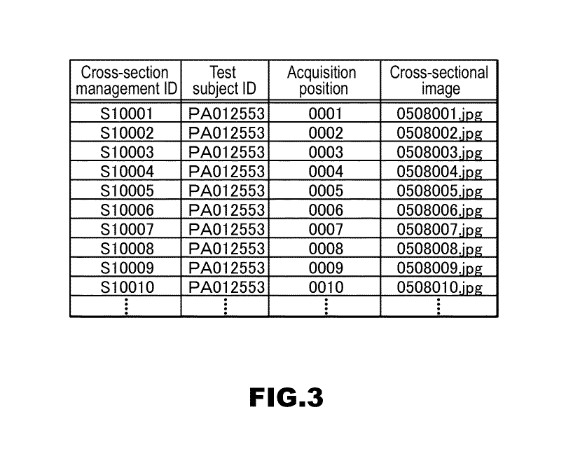

FIG. 3 shows cross-sectional image management information for managing the cross-sectional images stored in the cross-sectional image storage unit 11. The cross-sectional image management information has fields “cross-section management ID”, “test subject ID”, “acquisition position”, and “cross-sectional image”. “Cross-section management ID” is identifying information for managing each record (row) of the cross-sectional image management information. “Test subject ID” is information for identifying a test subject from which the cross-sectional image was captured, and, in this example, is expressed as a character string (which may include digits) allocated to the test subject. “Acquisition position” is identifying information indicating the position at which the cross-sectional image was acquired. In this example, “acquisition position” is used also as information indicating the order of the acquisition position, and is expressed as a serial integral number starting from “0001”. The smaller number indicates that the image was captured at a position closer to the head. “Acquisition position” may be, for example, the same between different test subjects. “Cross-sectional image” indicates a cross-sectional image, and, in this example, shows the file name of the cross-sectional image.

It is assumed that, in order to set a region of interest in a cross-sectional image of the patient with “test subject ID” being “PA012553”, the user first performs an operation on the operation accepting unit 12 so that “0508005.jpg”, which is “cross-sectional image” of the record (row) with “test subject ID” being “PA012553” and “acquisition position” being “0005”, is displayed on a monitor. Then, the operation accepting unit 12 accepts the operation that displays the cross-sectional image, and the display unit 19 reads the cross-sectional image “0508005.jpg” from the cross-sectional image storage unit 11, and displays the image on the monitor.

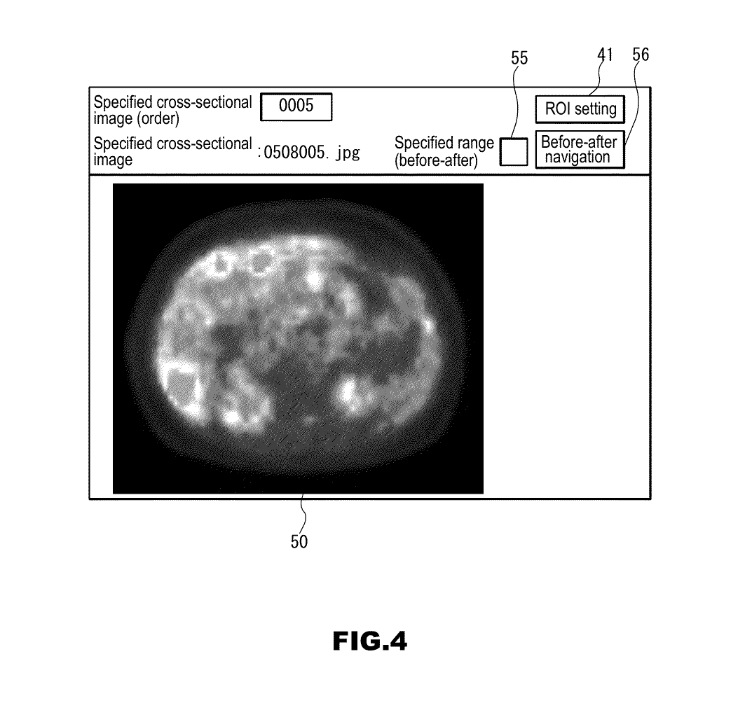

FIG. 4 is a view showing an example in which the display unit 19 displays the cross-sectional image “0508005.jpg”. The cross-sectional image shown in this drawing is a specified cross-sectional image 50.

It is then assumed that the user (e.g., a doctor, etc.) operates a menu or the like to display a cursor used to specify a region in order to set a region of interest, and performs an operation that specifies a region that is to be set as the region of interest. For example, if the user moves the mouse along the periphery of a region that is to be set as the region of interest in the cross-sectional image shown in FIG. 4, while clicking on the mouse button, a region having a contour that matches the movement line of the cursor is specified. This contour information is temporarily stored, for example, in a storage medium such as an unshown memory.

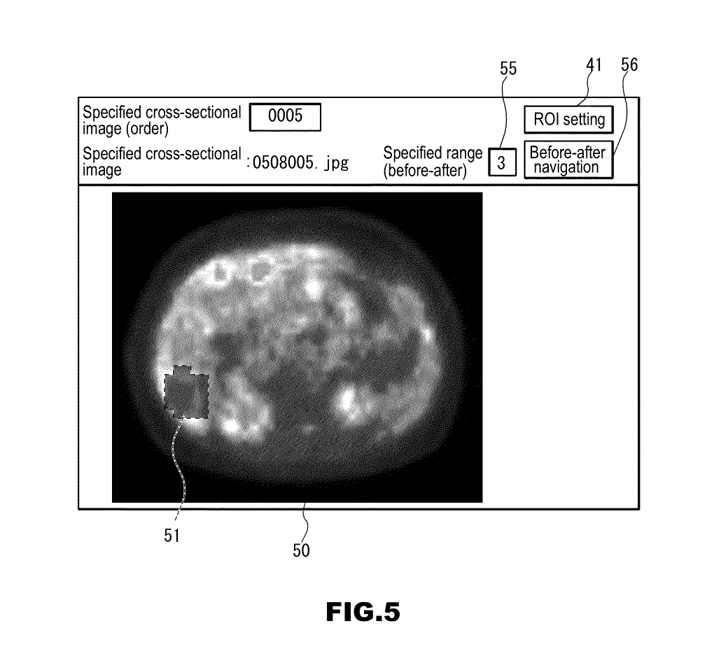

FIG. 5 is a view showing an example in which the display unit 19 displays a region 51 specified in the specified cross-sectional image “0508005.jpg”. In this drawing, for the sake of a description, the region 51 in the specified cross-sectional image 50 is indicated by the dotted line. Furthermore, in this example, a predetermined color is overlaid on the region 51. It is preferable that this color has a hue, brightness, or the like clearly different from that allocated to the specified cross-sectional image 50.

If the user operates the mouse or the like to click an “ROI setting” button 41 prepared in advance as shown in FIG. 4 in the state where the region is specified in this manner, the region-of-interest operation accepting unit 13 accepts an operation that sets the specified region as the region of interest. The region-of-interest setting information accumulating unit 14 acquires region-of-interest setting information for setting the specified region as the region of interest. The region-of-interest setting information set by the region-of-interest setting information accumulating unit 14 in this example is, for example, a group of the coordinates of all pixels included in the region of interest. The region-of-interest setting information accumulating unit 14 accumulates the acquired region-of-interest setting information in the region-of-interest setting information storage unit 15. The region of interest accumulated in the region-of-interest setting information storage unit 15 is provided with, for example, information for identifying a region of interest according to a predetermined rule. For example, the region of interest is provided with identifying information “0005-1”, obtained by combining the value of “acquisition position” of the cross-sectional image (i.e., “0005”) and the serial number indicating the order of the region of interest set in this cross-sectional image (i.e., “1”, in this example), with “-” (hyphen).

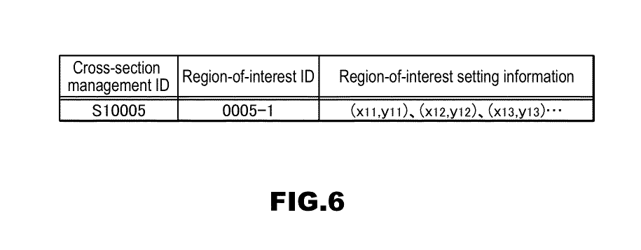

FIG. 6 is a table showing region-of-interest management information for managing the region-of-interest setting information accumulated in the region-of-interest setting information storage unit 15. The region-of-interest management information has fields “cross-section management ID”, “region-of-interest ID”, and “region-of-interest setting information”. “Cross-section management ID” corresponds to “cross-section management ID” in FIG. 3. In this example, “cross-section management ID” is used as information for identifying a cross-sectional image in which a region of interest has been set. “Region-of-interest ID” is the above-described information for identifying the region of interest. “Region-of-interest setting information” is region-of-interest setting information. In this specific example, it is assumed that the coordinates (x₁₁, y₁₁) and the like are coordinate values specifying one point on the cross-sectional image.

In this example, for the sake of convenience of the description, a case will be described in which only one region of interest is set in the cross-sectional image, but multiple regions of interest may be set by repeating the above-described process.

For example, it is assumed that the user operates the image processing apparatus 1 to input a numerical value for specifying the range of cross-sectional images in which an evaluation value and a related evaluation value are to be acquired, to an input field 55 on a screen displaying the cross-sectional image (specified cross-sectional image) as shown in FIG. 5. It is herein assumed that the input numerical value is “3”. This numerical value indicates that three cross-sectional images consecutively arranged before the currently displayed specified cross-sectional image and three cross-sectional images consecutively arranged thereafter are specified as cross-sectional images in which related evaluation values are to be acquired. If the user clicks a “before-after navigation” button 56, the operation accepting unit 12 accepts an operation for specifying the range of cross-sectional images in which an evaluation value or a related evaluation is to be acquired, and the evaluation value acquiring unit 16 starts a process that acquires related evaluation values and an evaluation value in the cross-sectional images and the specified cross-sectional image in the range specified above.

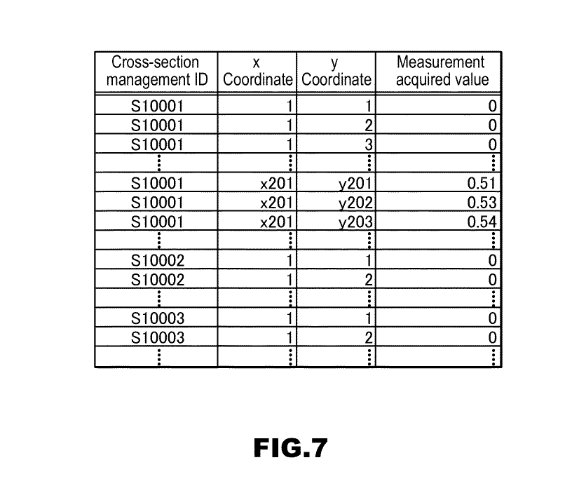

FIG. 7 is a table showing measurement acquired value management information, which is information having the coordinates of each pixel in a cross-sectional image stored in the cross-sectional image storage unit 11 and an SUV that is the measurement acquired value. It is assumed that the measurement acquired value management information in this example is stored in the cross-sectional image storage unit 11. The measurement acquired value management information has fields “cross-section management ID”, “x coordinate”, “y coordinate”, and “measurement acquired value”. “Cross-section management ID” is the same as “cross-section management ID” in FIG. 3 and the like. Furthermore, “x coordinate” and “y coordinate” are the x coordinate and the y coordinate of each pixel in a cross-sectional image corresponding to “cross-section management ID”. It is assumed that the coordinate values are, for example, pixel-based values. “Measurement acquired value” is the measurement acquired value corresponding to each pixel, and, in this example, is an SUV.

The evaluation value acquiring unit 16 reads “0005”, which is “acquisition position” of the specified cross-sectional image (currently displayed cross-sectional image, in this example) from the cross-sectional image management information shown in FIG. 3, and acquires the value “0002” obtained by subtracting “0003” from the value of “acquisition position” and “0008” obtained by adding “0003” thereto. Then, as described below, an evaluation value or a related evaluation value is acquired from the region of interest (if this cross-sectional image is the specified cross-sectional image) indicated by “region-of-interest setting information” shown in FIG. 6, or the region corresponding to the region of interest (if this cross-sectional image is not the specified cross-sectional image), in each cross-sectional image with “acquisition position” being “0002” to “0008”. In this example, a region configured by pixels at the same coordinates as those indicated by “region-of-interest setting information” in each cross-sectional image is considered as the region corresponding to the region of interest in that cross-sectional image.

First, the evaluation value acquiring unit 16 acquires the maximum of the SUVs corresponding to the coordinates indicated by “region-of-interest setting information” of the region-of-interest management information corresponding to the region of interest set in the current specified cross-sectional image, in the region-of-interest management information shown in FIG. 6, in the cross-sectional image with “acquisition position” being “0002”.

Specifically, the evaluation value acquiring unit 16 acquires “S10005”, which is “cross-section management ID” corresponding to the current specified cross-sectional image, that is, “cross-section management ID” of the record with “acquisition position” being “0005”, from among the records (rows) in the cross-sectional image management information shown in FIG. 3. Then, the value of “region-of-interest setting information” (coordinate group, in this example) is acquired from one of the records with “cross-section management ID” being “S10005” in the region-of-interest management information shown in FIG. 6. In this example, there is only one region of interest set in the current specified cross-sectional image, and, thus, there is only one record of the region-of-interest management information with “cross-section management ID” being “S10005”. Accordingly, the value of “region-of-interest setting information” of this record is acquired.

Next, the evaluation value acquiring unit 16 acquires “S10002”, which is “cross-section management ID” of the cross-sectional image with “acquisition position” being “0002”, from the cross-sectional image management information shown in FIG. 3. Then, the evaluation value acquiring unit 16 acquires the value of “measurement acquired value” in each record having a pair of “x coordinate” and “y coordinate” that match the coordinates indicated by the value of “region-of-interest setting information” acquired for the current specified cross-sectional image, from among the multiple records of the measurement acquired value management information with “cross-section management ID” being “S10002” shown in FIG. 7, compares the acquired values, and acquires the maximum of “measurement acquired value” as the related evaluation value. The evaluation value acquiring unit 16 temporarily stores this acquired maximum SUV, “acquisition position”, and “cross-section management ID” in association with each other in an unshown storage medium or the like. For example, if the maximum SUV is “4.6”, the evaluation value acquiring unit 16 temporarily stores this value, the acquisition position “0002”, and the cross-section management ID “S10002” in association with each other in an unshown storage medium. The maximum SUV acquired for the cross-sectional image with “acquisition position” being “0005” is the evaluation value. If there are multiple regions of interest set in the specified cross-sectional image, there are multiple records of the region-of-interest management information with “cross-section management ID” being “S10005”. Accordingly, the values of “region-of-interest setting information” in the respective records are sequentially acquired, and the above-described process is repeatedly performed, and, thus, an evaluation value and a related evaluation value are acquired as described above for each region of interest.

In a similar manner, the evaluation value acquiring unit 16 sequentially acquires the maximum SUVs as described above from the cross-sectional images with “acquisition position” being “0003” to “0008”, and accumulates the acquired maximum SUVs in association with “acquisition position” and “cross-section management ID” corresponding to the respective cross-sectional images in the unshown storage medium.

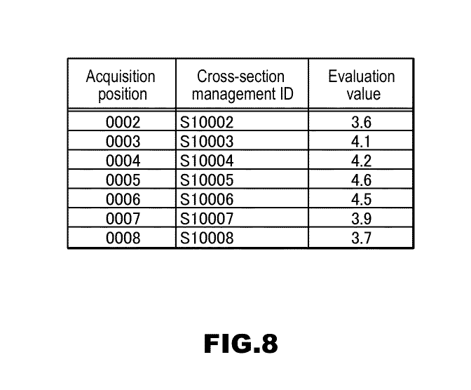

FIG. 8 is a table showing evaluation value management information for managing the evaluation value or the related evaluation value accumulated by the evaluation value acquiring unit 16 in the unshown storage medium. The evaluation value management information has fields “acquisition position”, “cross-section management ID”, and “evaluation value”. “Evaluation value” is the evaluation value or the related evaluation value.

The output unit 17 displays, on an unshown monitor of the image processing apparatus 1, the evaluation value or the related evaluation value acquired by the evaluation value acquiring unit 16 in association with “acquisition position”. In this example, the output unit 17 displays a bar graph in which a bar having a length corresponding to the evaluation value or the related evaluation value is associated with a field name (acquisition position ID, in this example) indicating the acquisition position. In this case, “acquisition position ID” may be considered as information for identifying a cross-sectional image.

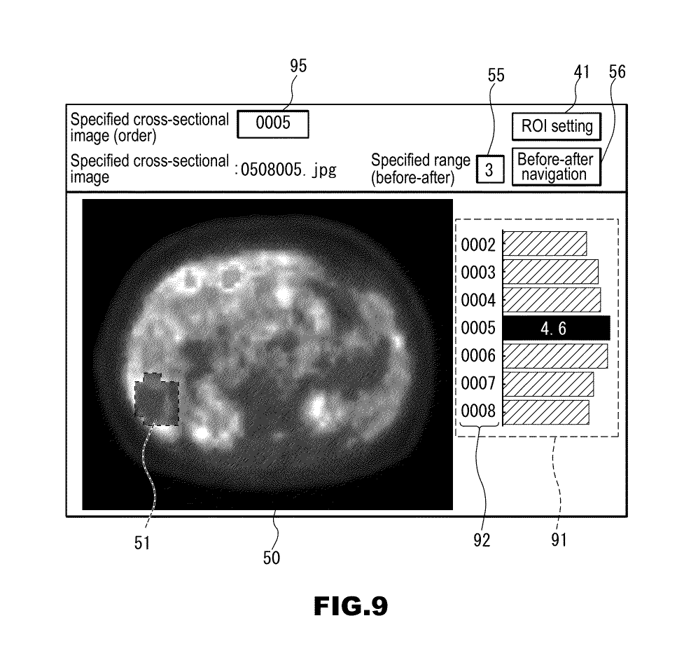

FIG. 9 is a view showing an output example by the output unit 17, wherein the output unit 17 displays, on an unshown monitor or the like, a bar graph 91 showing the evaluation value or the related evaluation value acquired by the evaluation value acquiring unit 16 from the cross-sectional images. A field name 92 corresponding to each bar of the bar graph indicates “acquisition position ID” corresponding to the specified cross-sectional image or the cross-sectional image in which the evaluation value or the related evaluation value was acquired. As the field name 92, “cross-section management ID” may be used instead of “acquisition position ID”. Furthermore, the output unit 17 detects a record with the highest evaluation in the evaluation value management information shown in FIG. 8, that is, a record with “evaluation value” having the largest value, and displays the graph 91 described above such that the bar corresponding to “acquisition position ID” included in the record with “evaluation value” having the largest value is displayed in a color different from those of the other bars, and such that the value of “evaluation value” is displayed on the bar. In FIG. 9, the value of “evaluation value” of the record corresponding to the cross-sectional image with “acquisition position” being “0005”, which is the specified cross-sectional image, is displayed on the bar corresponding to this “acquisition position”. As a result, the cross-sectional image corresponding to the evaluation value or the related evaluation value with the highest evaluation is emphasized. It is assumed that, in FIG. 9, the display unit 19 displays the cross-sectional image “0508005.jpg”, that is, the specified cross-sectional image 50 on the same monitor, as in FIG. 5.

If the user performs an operation that outputs the region-of-interest setting information set by the user for the cross-sectional image with “acquisition position” being “0005” (i.e., the specified cross-sectional image) from among the cross-sectional images with “test subject ID” being “PA012553”, the region-of-interest setting information output unit 18 reads “region-of-interest setting information” corresponding to “S10005”, which is “cross-section management ID” corresponding to the acquisition position “0005”, from the region-of-interest management information as shown in FIG. 6, and outputs this “region-of-interest setting information” in association with “S10005” (which is “cross-section management ID”), “test subject ID”, “acquisition position”, and the like. For example, the output herein is accumulation in an unshown storage medium. Accordingly, the region-of-interest setting information for setting a region of interest in a cross-sectional image is output.

Here, it is assumed that the user performs an operation that changes the region of interest set in the specified cross-sectional image in the state shown in FIG. 9. For example, it is assumed that the user performs an operation that deletes part of the region of interest on the display screen as shown in FIG. 9, such as selecting a partial region inside the region of interest and then selecting a command or the like to exclude this region from the region of interest.

In this case, the region-of-interest operation accepting unit 13 accepts the operation that changes the region of interest (operation that deletes part of the region of interest, in this example), and the region-of-interest setting information accumulating unit 14 acquires region-of-interest setting information for setting a region of interest after change according to the operation, and updates “region-of-interest setting information” of the region-of-interest management information shown in FIG. 6 stored in the region-of-interest setting information storage unit 15, to this region-of-interest setting information. For example, overwriting is performed.

Then, the evaluation value acquiring unit 16 uses the updated region-of-interest setting information to perform the above-described process, acquires an evaluation value and related evaluation values from the region of interest after change and regions corresponding thereto in the cross-sectional images with “acquisition position” being “0002” to “0008”, and updates the graph 91 displayed in FIG. 9 to a graph using the evaluation value and the related evaluation values.

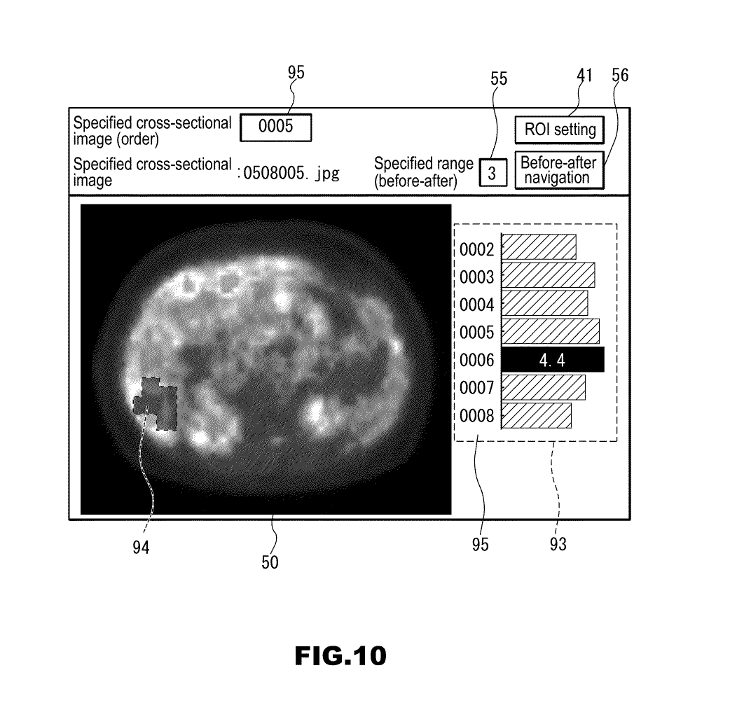

FIG. 10 is a view showing an example in which the output unit 17 outputs a graph showing an evaluation value and related evaluation values in the case where the region of interest has been changed. In this drawing, a graph 93 is a graph showing an evaluation value and related evaluation values acquired for the region of interest after change. A field name 95 is a field name after change. Furthermore, a region 94 indicates a region of interest after change, in the specified cross-sectional image 50 displayed by the display unit 19 on the same monitor. If the region of interest set in the specified cross-sectional image is changed in this manner, an evaluation value and related evaluation values are acquired and output for this region of interest after change.

Accordingly, an evaluation value and related evaluation values can be again acquired and output in real-time according to the change in the region of interest.

Here, it is assumed that the user performs an operation that changes the specified cross-sectional image in the state shown in FIG. 9. For example, it is assumed that the user performs an operation that changes the specified cross-sectional image by changing the value of the field 95, to which the value specifying the acquisition position of the specified cross-sectional images is to be input, from “0005” to “0006” in FIG. 9. The operation accepting unit 12 accepts the operation that changes the specified cross-sectional image to a cross-sectional image with the acquisition position “0006”. Then, the display unit 19 detects the record (row) with “test subject ID” being “PA012553” and “acquisition position” being “0006” from the cross-sectional image management information shown in FIG. 3, reads “0508006.jpg”, which is “cross-sectional image” of this record, from the cross-sectional image storage unit 11, and displays the image on the monitor. In this case, the operation accepting unit 12 updates, for example, values other than “region-of-interest setting information” of the region-of-interest management information in FIG. 6, such as values of “cross-section management ID” and “region-of-interest ID”, to values corresponding to the cross-sectional image after change, such as “S10006” and “0006-1”.

The evaluation value acquiring unit 16 uses this cross-sectional image “0508005.jpg” as the specified cross-sectional image and the numerical value “0003” input to the input field 55 before the specified cross-sectional image is changed, to perform a process that acquires related evaluation values and an evaluation value from three cross-sectional images consecutively arranged before the currently displayed specified cross-sectional image with “acquisition position” being “0006”, three cross-sectional images consecutively arranged after the specified cross-sectional image, and the specified cross-sectional image, as described above. That is to say, an evaluation value and evaluation value management information are acquired in the cross-sectional images with the acquisition positions in the range of “0003” to “0009”. In this case, the region-of-interest setting information for setting a region of interest in the immediately previous specified cross-sectional image with “acquisition position” being “0005” is used as region-of-interest setting information for setting a region of interest in the specified cross-sectional image after change. That is to say, the region-of-interest setting information shown in FIG. 6 stored in the region-of-interest setting information storage unit 15 is used as the region-of-interest setting information for the specified cross-sectional image after change. The following process is similar to that described above, and, thus, a description thereof has been omitted.

Accordingly, an evaluation value and related evaluation values can be again acquired and output in real-time according to the change in the specified cross-sectional image.

As described above, according to this embodiment, the user can compare an evaluation value in the region of interest set in the specified cross-sectional image with a related evaluation value in a region corresponding to the region of interest, in one or more other cross-sectional images, and, for example, can easily judge whether or not the region of interest set in the specified cross-sectional image is a proper region without checking the other cross-sectional images, and can easily set a proper region of interest in a cross-sectional image.

In the foregoing embodiment, each processing (each function) may be realized as integrated processing using a single apparatus (system), or may be realized as distributed processing using multiple apparatuses.

Furthermore, in the foregoing embodiment, the case was described in which the image processing apparatus is a stand-alone apparatus, but the image processing apparatus may be either a stand-alone apparatus or a server apparatus in a server-client system. In the latter case, the output unit and the accepting unit use a communication line to accept input or output a screen.

Furthermore, in the foregoing embodiment, each constituent element may be configured by dedicated hardware, or alternatively, constituent elements that can be realized as software may be realized by executing a program. For example, each constituent element may be realized by a program execution unit such as a CPU reading and executing a software program stored in a storage medium such as a hard disk or a semiconductor memory.

The software that realizes the image processing apparatus in the foregoing embodiment may be the following sort of program. Specifically, this program is a program used in a state where a computer can access: a cross-sectional image storage unit in which multiple cross-sectional images, which are images showing cross-sections of a living body produced using measured values, and are multiple images respectively acquired at different multiple positions in a predetermined direction, are stored in association with the arrangement order of the acquisition positions; and a region-of-interest setting information storage unit in which region-of-interest setting information, which is information for setting at least one region of interest in a specified cross-sectional image, is stored; the program causing the computer to function as: an operation accepting unit that accepts an operation that specifies a cross-sectional image stored in the cross-sectional image storage unit; an evaluation value acquiring unit that acquires, using the measured values, an evaluation value, which is a value for evaluating a region of interest in the specified cross-sectional image specified by the operation, for each region of interest indicated by the region-of-interest setting information, and acquires, using the measured values, a related evaluation value, which is a value for evaluating a region in at least one cross-sectional image other than the specified cross-sectional image, for each region corresponding to each region of interest indicated by the region-of-interest setting information; and an output unit that outputs the evaluation value and the related evaluation value acquired by the evaluation value acquiring unit, in association with the specified cross-sectional image corresponding to the evaluation value and the cross-sectional image corresponding to the related evaluation value.

It should be noted that, in the program, processing that is performed by hardware in a step of transmitting information, a step of receiving information, or the like, such as processing performed by a modem or an interface card in the transmitting step (processing that can be performed only by hardware), is not included.

Furthermore, in the program, the functions realized by the program do not include functions that can be realized only by hardware. For example, functions that can be realized only by hardware, such as a modem or an interface card, in an acquiring unit that acquires information or an output unit that outputs information are not included in the functions realized by the above-described program.

Furthermore, the computer that executes this program may be a single computer, or may be multiple computers. More specifically, centralized processing may be performed, or distributed processing may be performed.

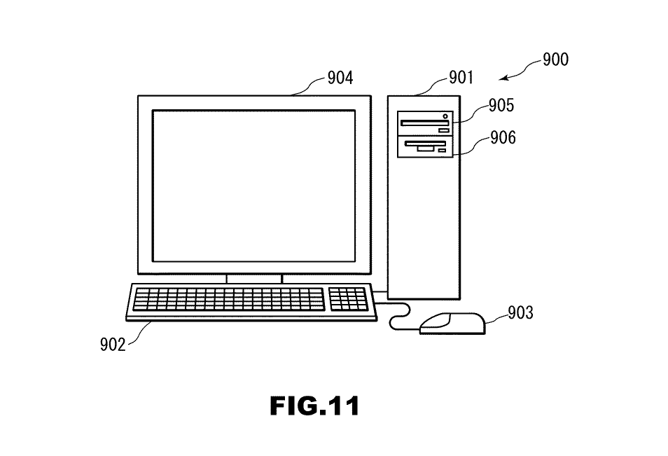

FIG. 11 is a schematic view showing an exemplary appearance of a computer that executes the program described above to realize the image processing apparatus in the foregoing embodiment. The foregoing embodiment may be realized using computer hardware and computer programs executed thereon.

In FIG. 11, a computer system 900 is provided with a computer 901 including a compact disk read only memory (CD-ROM) drive 905 and a Floppy (registered trademark) disk (FD) drive 906, a keyboard 902, a mouse 903, and a monitor 904.

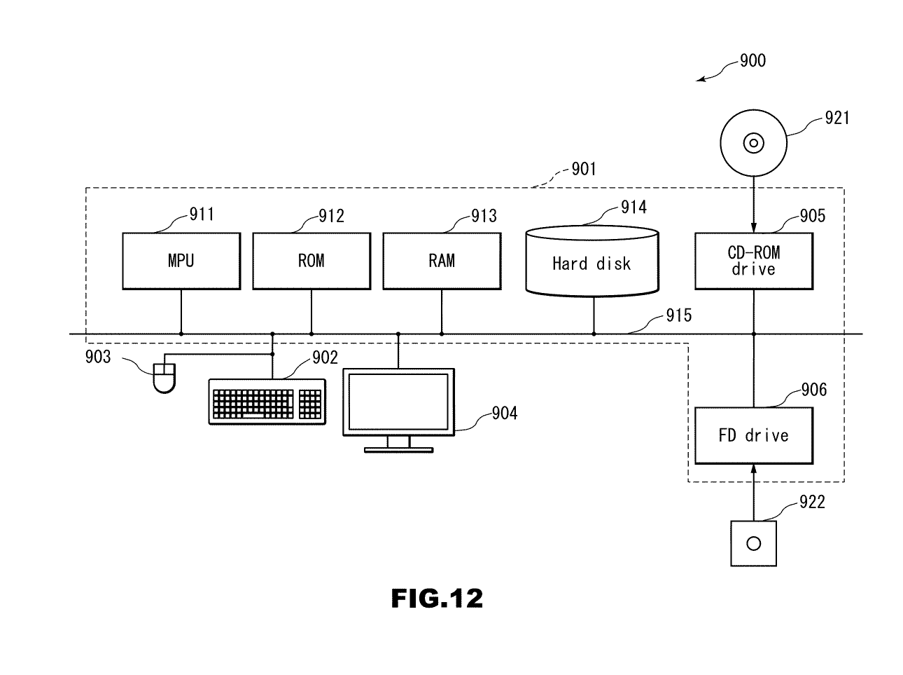

FIG. 12 is a diagram showing an internal configuration of the computer system 900. In FIG. 12, the computer 901 is provided with, not only the CD-ROM drive 905 and the FD drive 906, but also a micro processing unit (MPU) 911, a ROM 912 in which a program such as a boot up program is to be stored, a random access memory (RAM) 913 that is connected to the MPU 911 and in which a command of an application program is temporarily stored, and a temporary storage area is to be provided, a hard disk 914 in which an application program, a system program, and data are stored, and a bus 915 that connects the MPU 911, the ROM 912, and the like. Note that the computer 901 may include an unshown network card for providing a connection to a LAN.

The program for causing the computer system 900 to execute the functions of the image processing apparatus and the like in the foregoing embodiment may be stored in a CD-ROM 921 or an FD 922 that is inserted into the CD-ROM drive 905 or the FD drive 906, and be transmitted to the hard disk 914. Alternatively, the program may be transmitted via an unshown network to the computer 901 and stored in the hard disk 914. At the time of execution, the program is loaded into the RAM 913. The program may be loaded from the CD-ROM 921 or the FD 922, or directly from a network.

The program does not necessarily have to include, for example, an operating system (OS) or a third party program to cause the computer 901 to execute the functions of the image processing apparatus in the foregoing embodiment. The program may only include a command portion to call an appropriate function (module) in a controlled mode and obtain desired results. The manner in which the computer system 900 operates is well known, and, thus, a detailed description thereof has been omitted.

The present invention is not limited to the embodiment set forth herein. Various modifications are possible within the scope of the present invention.

### INDUSTRIAL APPLICABILITY

As described above, the image processing apparatus according to the present invention is suitable as an apparatus for processing a cross-sectional image and the like, and is particularly useful as an apparatus for setting a region of interest in a cross-sectional image and the like.

1. An image processing apparatus, comprising:
a cross-sectional image storage unit in which multiple cross-sectional images, which are images showing cross-sections of a living body produced using measured values, and are multiple images respectively acquired at different multiple positions in a predetermined direction, are stored in association with the arrangement order of the acquisition positions;
an operation accepting unit that accepts an operation that specifies a cross-sectional image stored in the cross-sectional image storage unit;
a region-of-interest setting information storage unit in which region-of-interest setting information, which is information for setting at least one region of interest in a specified cross-sectional image specified by the operation, is stored;
an evaluation value acquiring unit that acquires, using the measured values, an evaluation value, which is a value for evaluating a region of interest in the specified cross-sectional image, for each region of interest indicated by the region-of-interest setting information, and acquires, using the measured values, a related evaluation value, which is a value for evaluating a region in at least one cross-sectional image other than the specified cross-sectional image, for each region corresponding to each region of interest indicated by the region-of-interest setting information; and
an output unit that outputs the evaluation value and the related evaluation value acquired by the evaluation value acquiring unit, in association with the specified cross-sectional image corresponding to the evaluation value and the cross-sectional image corresponding to the related evaluation value.

2. The image processing apparatus according to claim 1, wherein the evaluation value acquiring unit acquires a related evaluation value in at least one cross-sectional image whose arrangement order is consecutive with that of the specified cross-sectional image.

3. The image processing apparatus according to claim 1, further comprising:
a region-of-interest operation accepting unit that accepts an operation that changes the region of interest; and
a region-of-interest setting information accumulating unit that accumulates, in the region-of-interest setting information storage unit, region-of-interest setting information for setting a region of interest after change according to the change operation;
wherein the evaluation value acquiring unit acquires the evaluation value and the related evaluation value for the region of interest after change.

4. The image processing apparatus according to claim 1,
wherein the operation accepting unit further accepts an operation that changes the specified cross-sectional image,
the image processing apparatus further comprises a region-of-interest setting information accumulating unit that acquires, for the specified cross-sectional image after change, the same region-of-interest setting information as that of the specified cross-sectional image before change, and accumulates the region-of-interest setting information in the region-of-interest setting information storage unit, and
the evaluation value acquiring unit acquires the evaluation value and the related evaluation value in the specified cross-sectional image after change and at least one cross-sectional image other than the specified cross-sectional image.

5. The image processing apparatus according to claim 1, wherein the output unit outputs the evaluation value and the related evaluation value using at least one of a bar graph, a graph other than a bar graph, a color brightness, a color tone, and a numerical value.

6. The image processing apparatus according to claim 1, wherein the output unit performs output such that the specified cross-sectional image or the cross-sectional image associated with the evaluation value or the related evaluation value with the highest evaluation is emphasized.

7. An image processing method, using: a cross-sectional image storage unit in which multiple cross-sectional images, which are images showing cross-sections of a living body produced using measured values, and are multiple images respectively acquired at different multiple positions in a predetermined direction, are stored in association with the arrangement order of the acquisition positions; an operation accepting unit; a region-of-interest setting information storage unit in which region-of-interest setting information, which is information for setting at least one region of interest in a specified cross-sectional image specified by an operation accepted by the operation accepting unit, is stored; an evaluation value acquiring unit; and an output unit,
the method comprising:
an operation accepting step of the operation accepting unit accepting an operation that specifies a cross-sectional image stored in the cross-sectional image storage unit;
an evaluation value acquiring step of the evaluation value acquiring unit acquiring, using the measured values, an evaluation value, which is a value for evaluating a region of interest in the specified cross-sectional image, for each region of interest indicated by the region-of-interest setting information, and acquiring, using the measured values, a related evaluation value, which is a value for evaluating a region in at least one cross-sectional image other than the specified cross-sectional image, for each region corresponding to each region of interest indicated by the region-of-interest setting information; and
an output step of the output unit outputting the evaluation value and the related evaluation value acquired in the evaluation value acquiring step, in association with the specified cross-sectional image corresponding to the evaluation value and the cross-sectional image corresponding to the related evaluation value.

8. A non-transitory computer readable storage medium in which a program is stored, the program being used in a state where a computer can access: a cross-sectional image storage unit in which multiple cross-sectional images, which are images showing cross-sections of a living body produced using measured values, and are multiple images respectively acquired at different multiple positions in a predetermined direction, are stored in association with the arrangement order of the acquisition positions; and a region-of-interest setting information storage unit in which region-of-interest setting information, which is information for setting at least one region of interest in a specified cross-sectional image, is stored,
the program causing the computer to function as:
an operation accepting unit that accepts an operation that specifies a cross-sectional image stored in the cross-sectional image storage unit;
an evaluation value acquiring unit that acquires, using the measured values, an evaluation value, which is a value for evaluating a region of interest in the specified cross-sectional image specified by the operation, for each region of interest indicated by the region-of-interest setting information, and acquires, using the measured values, a related evaluation value, which is a value for evaluating a region in at least one cross-sectional image other than the specified cross-sectional image, for each region corresponding to each region of interest indicated by the region-of-interest setting information; and
an output unit that outputs the evaluation value and the related evaluation value acquired by the evaluation value acquiring unit, in association with the specified cross-sectional image corresponding to the evaluation value and the cross-sectional image corresponding to the related evaluation value.
